(19) United States
(12) Patent Application Publication
(10) Pub. No.: US 2020/0160208 A1
(43) Pub. Date: May 21, 2020

(54) MODEL SHARING AMONG EDGE DEVICES

(71) Applicant: General Electric Company, Schenectady, NY (US)

(72) Inventors: Huan TAN, Clifton Park, NY (US); Colin PARRIS, Brookfield, CT (US); Xiao BIAN, Niskayuna, NY (US); Shaopeng LIU, Clifton Park, NY (US); Kiersten RALSTON, Niskayuna, NY (US); Guiju SONG, Niskayuna, NY (US); Dayu HUANG, Niskayuna, NY (US)

(21) Appl. No.: 16/191,993

(22) Filed: Nov. 15, 2018

(51) Int. Cl. G06N 20/00; G06K 9/32; G05B 17/02

(52) U.S. Cl. CPC G06N 20/00; G05B 17/02; G06K 9/3233

(57) ABSTRACT

The example embodiments are directed to a system and method for sharing machine learning model parameters among edge devices in a clustered group of edge devices sensing data about an industrial asset. In one example, the method may include one or more of storing unique parameters of a machine learning (ML) model associated with an industrial asset which are unique with respect to unique parameters of other edge systems in the group of edge systems, receiving common parameter information from the group of edge systems which is shared among the group of edge systems, generating updated parameter values for an ML model based on a combination of the unique parameters and the received common parameter information, and executing the updated ML model based on incoming data from the industrial asset to generate predictive information about the industrial asset.

### BACKGROUND

Machine and equipment assets are engineered to perform particular tasks as part of a process. For example, assets can include, among other things, industrial manufacturing equipment on a production line, drilling equipment for use in mining operations, wind turbines that generate electricity on a wind farm, transportation vehicles (trains, subways, airplanes, etc.), gas and oil refining equipment, and the like. As another example, assets may include devices that aid in diagnosing patients such as imaging devices (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the overwhelming adoption of cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

An industrial internet of things (IIoT) network incorporates machine learning and big data technologies to harness the sensor data, machine-to-machine (M2M) communication and automation technologies that have existed in industrial settings for years. The driving philosophy behind IIoT is that smart machines are better than humans at accurately and consistently capturing and communicating real-time data. This data enables companies to pick up on inefficiencies and problems sooner, saving time and money and supporting business intelligence (BI) efforts. IIoT holds great potential for quality control, sustainable and green practices, supply chain traceability and overall supply chain efficiency.

In an IIoT, edge devices sense or otherwise capture data and submit the data to a cloud platform or other central host. Data provided from edge devices may be used in a large variety of industrial applications. In a cloud-edge system, artificial intelligence (AI) models having machine learning capabilities are maintained in the cloud and operated based on key information that is collected from different edge devices. However, AI models may deteriorate over time for numerous reasons such as changes in industrial asset operation, new parts being added, updates, maintained requirements, and the like. To address these issues, an operator must manually update (on-premises or remotely) the AI model. This operation can take significant time. Therefore, a mechanism is needed which can improve model performance without the need for an operator to install updates manually.

### SUMMARY

According to an aspect of an example embodiment, a computing system may include one or more of a storage configured to store unique parameters of a machine learning (ML) model associated with an industrial asset which are unique to the edge system with respect to unique parameters of other edge systems among a group of edge systems, a network interface configured to receive common parameter information from the group of edge systems which is shared among the group of edge systems, and a processor configured to generate updated parameter values for an ML model based on a combination of the unique parameters and the received common parameter information, and execute the updated ML model based on incoming data from the industrial asset to generate predictive information about the industrial asset.

According to an aspect of another example embodiment, a method may include one or more of storing, by an edge system among a group of edge systems, unique parameters of a machine learning (ML) model associated with an industrial asset which are unique with respect to unique parameters of other edge systems in the group of edge systems, receiving common parameter information from the group of edge systems which is shared among the group of edge systems, generating updated parameter values for an ML model based on a combination of the unique parameters and the received common parameter information, and executing the updated ML model based on incoming data from the industrial asset to generate predictive information about the industrial asset.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing system for industrial software and hardware in accordance with an example embodiment.

FIG. 2 is a diagram illustrating a group of edge devices sensing data from an industrial asset in accordance with an example embodiment.

FIG. 3A is a diagram illustrating a process of sharing common parameter components among edge devices in accordance with example embodiments.

FIG. 3B is a graph illustrating common model components converging over time in accordance with example embodiment.

FIG. 4 is a diagram illustrating a method for updating parameters of an ML model on an edge device in accordance with an example embodiment.

FIG. 5 is a diagram illustrating a computing system configured for use within any of the example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

In a traditional cloud-edge environment within an industrial network such as an Industrial Internet of Things (IIoT), edge devices collect data from industrial machine and/or equipment referred to as industrial assets. Often, edge devices have one or more machine learning (ML) models, also referred to as artificial intelligence (AI) models executing therein which help identify and predict information about an asset such as when maintenance may be necessary, if a control setting needs to be changed, if a part needs to be replaced, and the like. The ML models are typically installed by a human through manual installation at the site. In some newer systems, models may be downloaded from a cloud platform and configured by a remote user through various configuration settings. However, these process require significant effort on the user's part to detect what model needs to be installed, whether the model is running correctly, what types of additional information may be needed to update the model, and the like.

The example embodiments overcome the drawbacks of the prior art by providing an edge-to-edge communication system in which edge devices communicate with one another to update machine learning models. Each edge system may be configured with edge-specific components for the ML model such as specific weights and coefficients which may be particular to a location at which a sensor is positioned with respect to the asset, or the like. Meanwhile, each of the edge devices may share information about these edge-specific components to create a common component (e.g., a virtual average of all edge models) which can also be used to update the ML model. In this way, each of the edge systems may share information about various ML models executing therein to improve accuracy of the ML models as a group, while still maintaining edge-specific components. Each edge device may update its respective ML model based on the shared parameters from other edge devices which can improve the accuracy of the ML models across each of the edge devices that participate in the sharing.

According to various aspects, edge devices may use machine learning models to monitor and predict attributes associated with the industrial asset. Often, an ML model is processed on edge data that is collected from sensors on or about the industrial asset. For example, sensors may capture time-series data (temperature, pressure, vibration, etc.) about an industrial asset which can be processed using ML models to identify operating characteristics of the industrial asset that need to be changed. As another example, images may be captured of an industrial asset which can be processed using ML models to identify various image features or regions of interest (e.g., damage, wear, tear, etc.) to the industrial asset. In order for these models to operate accurately, the models must receive.

In the example of image data, the image data may be used to detect a specific feature from an industrial asset (e.g., damage to a surface of the asset, etc.) A machine learning model may be trained to identify how likely such a feature exists in an image. A result of the ML model output may be a data point for the image where the data point is arranged in a multi-dimensional feature space with a likelihood of the feature existing within the image being arranged on one axis (e.g., y axis) and time on another axis (e.g., x axis). As another example, time-series data may be used to monitor how a machine or equipment is operating over time. Time-series data may include temperature, pressure, speed, etc. Here, the ML model may be trained to identify how likely it is that the operation of the asset is normal or abnormal based on the incoming-time series data.

In some cases, data captured from the industrial asset may be received in raw form and converted into feature space by an ML model. The data may be processed in clusters or segments. Each data point in a cluster may represent an image captured by a camera or a reading sensed by a sensor. The edge system may convert the raw data into data points within the feature space using an ML model. The resulting data points may be graphed as a pattern of data that can be compared with a pattern of data of a previous data clusters. In the examples herein, the common ML model component may be generally used by all edge devices when processing incoming data, while edge-specific ML model components may be used by only the respective edge device where they are stored.

The system and method described herein may be implemented via a program or other software that may be used in conjunction with applications for managing machine and equipment assets hosted within an industrial internet of things (IIoT). An IIoT may connect assets, such as turbines, jet engines, locomotives, elevators, healthcare devices, mining equipment, oil and gas refineries, and the like, to the Internet or cloud, or to each other in some meaningful way such as through one or more networks. The cloud can be used to receive, relay, transmit, store, analyze, or otherwise process information for or about assets and manufacturing sites. In an example, a cloud computing system includes at least one processor circuit, at least one database, and a plurality of users and/or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

Assets may be outfitted with one or more sensors (e.g., physical sensors, virtual sensors, etc.) configured to monitor respective operations or conditions of the asset and the environment in which the asset operates. Data from the sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like.

The edge-cloud system may be used in conjunction with applications and systems for managing machine and equipment assets and can be hosted within an IIoT. For example, an IIoT may connect physical assets, such as turbines, jet engines, locomotives, healthcare devices, and the like, software assets, processes, actors, and the like, to the Internet or cloud, or to each other in some meaningful way such as through one or more networks. The system described herein can be implemented within a “cloud” or remote or distributed computing resource. The cloud can be used to receive, relay, transmit, store, analyze, or otherwise process information for or about assets. In an example, a cloud computing system includes at least one processor circuit, at least one database, and a plurality of users and assets that are in data communication with the cloud computing system. The cloud computing system can further include or can be coupled with one or more other processor circuits or modules configured to perform a specific task, such as to perform tasks related to asset maintenance, analytics, data storage, security, or some other function.

While progress with industrial and machine automation has been made over the last several decades, and assets have become ‘smarter,’ the intelligence of any individual asset pales in comparison to intelligence that can be gained when multiple smart devices are connected together, for example, in the cloud. Aggregating data collected from or about multiple assets can enable users to improve business processes, for example by improving effectiveness of asset maintenance or improving operational performance if appropriate industrial-specific data collection and modeling technology is developed and applied.

The integration of machine and equipment assets with the remote computing resources to enable the IIoT often presents technical challenges separate and distinct from the specific industry and from computer networks, generally. To address these problems and other problems resulting from the intersection of certain industrial fields and the IIoT, the example embodiments provide a mechanism for triggering an update to a ML model upon detection that the incoming data is no longer represented by the data pattern within the training data which was used to initially train the ML model.

The Predix™ platform available from GE is a novel embodiment of such an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial or healthcare based assets can be uniquely situated to leverage its understanding of assets themselves, models of such assets, and industrial operations or applications of such assets, to create new value for industrial customers through asset insights.

As described in various examples herein, data may include a raw collection of related values of an asset or a process/operation including the asset, for example, in the form of a stream (in motion) or in a data storage system (at rest). Individual data values may include descriptive metadata as to a source of the data and an order in which the data was received, but may not be explicitly correlated. Information may refer to a related collection of data which is imputed to represent meaningful facts about an identified subject. As a non-limiting example, information may be a dataset such as a dataset which has been determined to represent temperature fluctuations of a machine part over time.

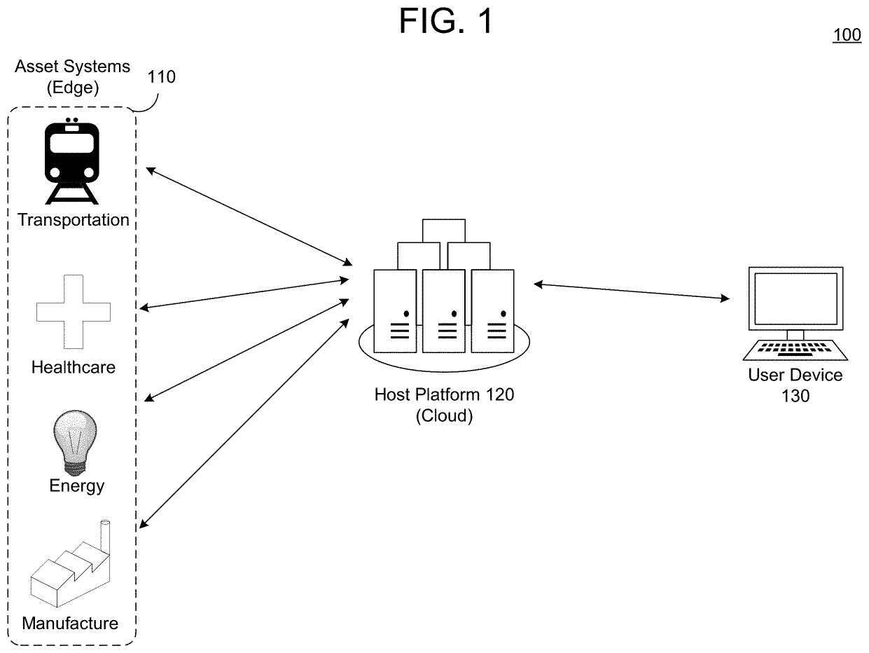

FIG. 1 illustrates a cloud computing system 100 for industrial software and hardware in accordance with an example embodiment. Referring to FIG. 1, the system 100 includes a plurality of assets 110 which may be included within an edge of an IIoT and which may transmit raw data to a source such as cloud computing platform 120 where it may be stored and processed. It should also be appreciated that the cloud platform 120 in FIG. 1 may be replaced with or supplemented by a non-cloud based platform such as a server, an on-premises computing system, and the like. Assets 110 may include hardware/structural assets such as machine and equipment used in industry, healthcare, manufacturing, energy, transportation, and that like. It should also be appreciated that assets 110 may include software, processes, actors, resources, and the like. A digital replica (i.e., a digital twin) of an asset 110 may be generated and stored on the cloud platform 120. The digital twin may be used to virtually represent an operating characteristic of the asset 110.

The data transmitted by the assets 110 and received by the cloud platform 120 may include raw time-series data output as a result of the operation of the assets 110, and the like. Data that is stored and processed by the cloud platform 120 may be output in some meaningful way to user devices 130. In the example of FIG. 1, the assets 110, cloud platform 120, and user devices 130 may be connected to each other via a network such as the Internet, a private network, a wired network, a wireless network, etc. Also, the user devices 130 may interact with software hosted by and deployed on the cloud platform 120 in order to receive data from and control operation of the assets 110.

Software and hardware systems can be used to enhance or otherwise used in conjunction with the operation of an asset and a digital twin of the asset (and/or other assets), may be hosted by the cloud platform 120, and may interact with the assets 110. For example, ML models (or AI models) may be used to optimize a performance of an asset or data coming in from the asset. As another example, the ML models may be used to predict, analyze, control, manage, or otherwise interact with the asset and components (software and hardware) thereof. The ML models may also be stored in the cloud platform 120 and/or at the edge (e.g. asset computing systems, edge PC's, asset controllers, etc.)

A user device 130 may receive views of data or other information about the asset as the data is processed via one or more applications hosted by the cloud platform 120. For example, the user device 130 may receive graph-based results, diagrams, charts, warnings, measurements, power levels, and the like. As another example, the user device 130 may display a graphical user interface that allows a user thereof to input commands to an asset via one or more applications hosted by the cloud platform 120.

In some embodiments, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function, process, operation, etc., of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

For example, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

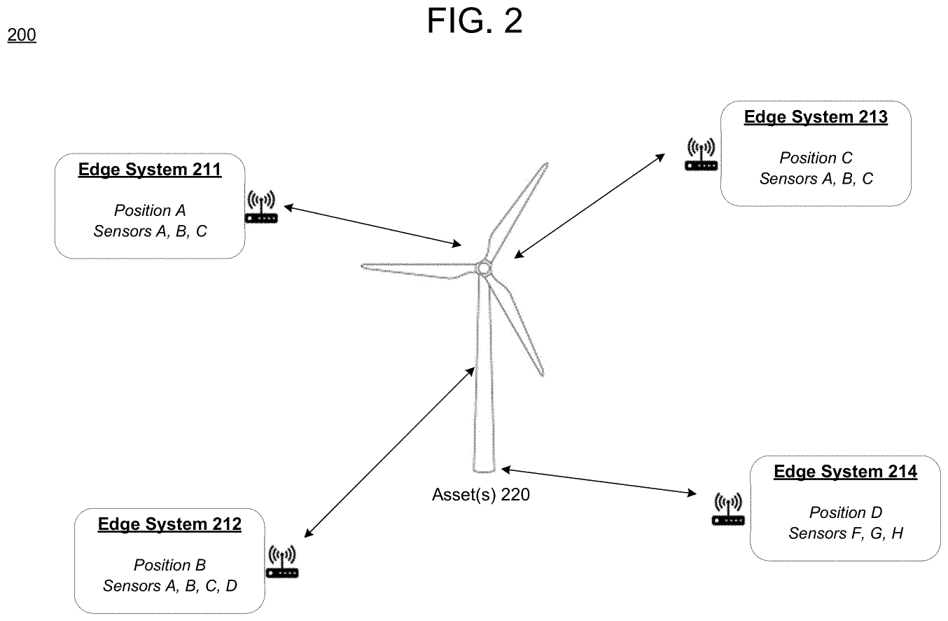

FIG. 2 illustrates a system 200 including a group of edge devices 211-214 sensing data from an industrial asset 220 in accordance with an example embodiment. Referring to the example of FIG. 2, the edge devices 211-214 may be clustered in groups and may receive data from sensors that are attached to the asset 220 or positioned around the asset 220. The sensors may have similar locations, although not exactly the same. Therefore, the edge devices may receive similar data. The benefits of using a group of edge devices 211-214 and corresponding sensors is that data may be sensed from different locations in and around the asset 220 which can provide a more detailed analysis of the operation or the condition of the industrial asset 220.

In the example of FIG. 2, the industrial asset 220 is a wind turbine having sensors affixed at different positions around the wind turbine. For example, these sensors may be used to detect a common attribute or different attributes such as rotational force, translation, acceleration, vibration, or the like. Although the sensors should sense similar data patterns, the rotational force (or other attribute) at the base of the wind turbine may have a different profile than the rotational force at the top of the wind turbine. Therefore, the ML model used by the edge device acquiring sensor data from the bottom of the wind turbine may have a different ML model parameters than an ML Model used by an edge device acquiring sensor data from the top of the wind turbine, although these models may have some overlap with weights and coefficient data.

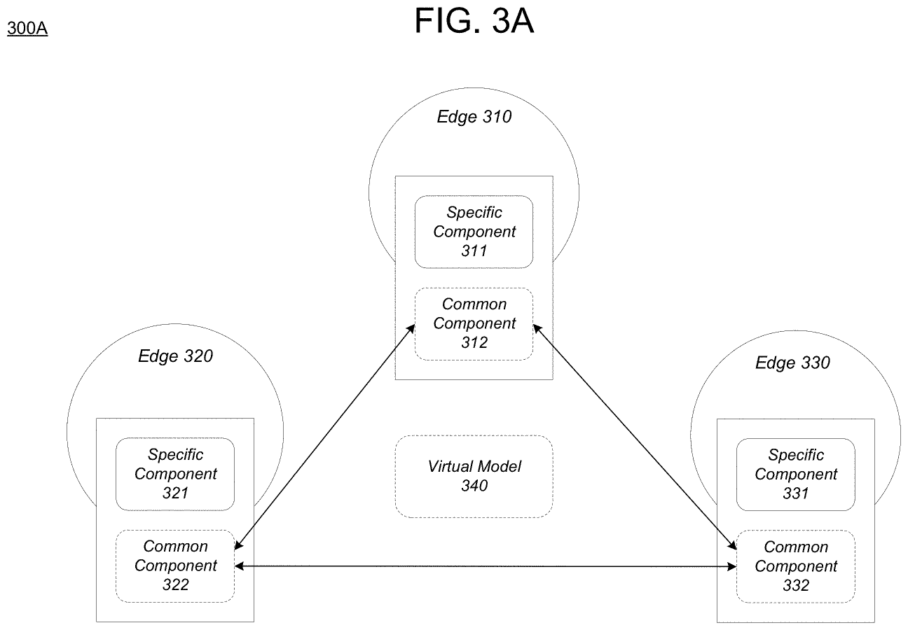

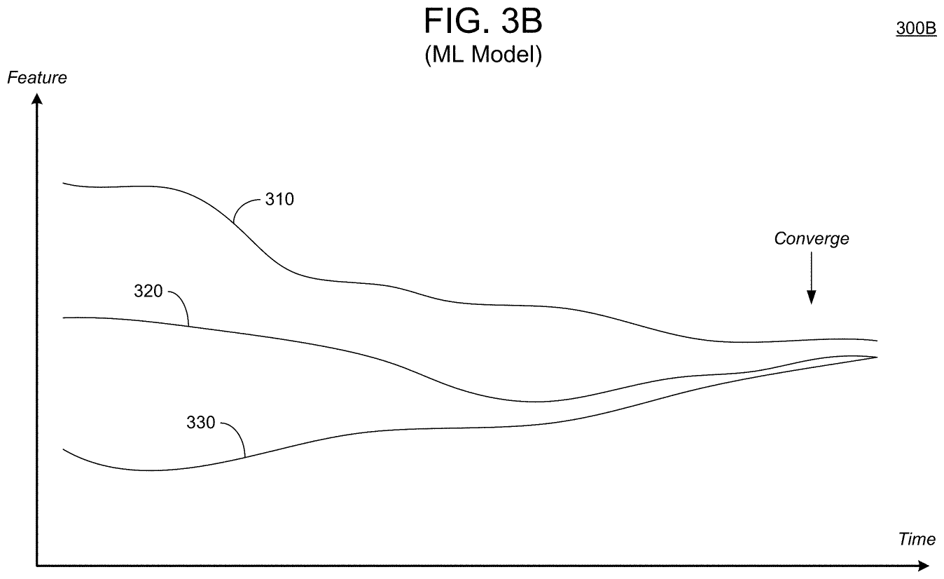

FIG. 3A illustrates a process 300A of three edge devices 310, 320, and 330 within a group sharing common parameter components 312, 322, and 332, in accordance with an example embodiment to generate a common component 340, and FIG. 3B is a graph that illustrates a mapping of data transformed by ML models stored at the three edge devices 310, 320, and 330 of FIG. 3A being mapped into feature space and converging over time in accordance with example embodiment. In this example, each edge device includes a specific model component 311, 321, and 331, respectively, and a shared component model component 312, 322, and 332, respectively. The shared model components 312, 322, and 332 are shared by the edge devices 310, 320, and 330 among each other to generate the virtual component 340. Then, each device may alter its corresponding edge specific model component 311, 321, and 331, based on the common virtual component 340.

In the example of FIG. 3A, the edge device 310 may share a common component 312 about is respective model parameters with the edge devices 320 and 330. Likewise, the edge device 320 may share a common component 322 about its respective model parameters with the edge devices 310 and 330. Further, the edge device 330 may share a common component 332 with the edge devices 310 and 320. In response, each edge device 31, 320, and 330 may compute a value of the virtual component 340 based on a combination of the shared components 312, 322, and 332 from all edge devices 310, 320, and 330 within the group.

Meanwhile, FIG. 3B illustrates the results of the ML models executed by the edge devices 310, 320, and 330 over time as they learn from each other's specific components through the virtual model 340. Here, the ML model of each edge device transforms raw data into features space using a ML model that is based on a combination of edge-specific parameters that are unique to the edge device, and the virtual parameter(s) that is shared among the edge devices. The result is that the ML models start to produce similar results and converge over time within the features space. In this case, after the sharing of the parameters with each other, and updating of the respective ML models, the patterns of data detection created by the respective ML models executed on each edge device 310, 320, and 330 being to converge creating a more accurate distributed model on each edge device.

Referring again to FIG. 3A, the edge devices 310, 320, and 330 may have similar locations and similar data. There are two types of components with each edge device 1) a common model component (virtual component 340) that is shared among each edge device in the cluster and 2) a specific model component which is unique (specific parameters) to the edge device or at least not shared among all edge devices in the cluster/community.

In this example, the edge devices 310, 320, and 330 are similar so they can share the parameters of a ML model among each other. Examples of parameters include weights and/or coefficients of a machine learning algorithm such as a classification algorithm, a regression algorithm, and the like. The example of FIG. 3A illustrates the edge devices 310, 320, and 330 sharing parameters to prepare a common model (or virtual model 340) as shown in FIG. 3A. There is no central server needed. The sharing/triggering may be performed by any of the edge devices 310-330.

According to various embodiments, sharing of parameters (represented by items 312, 322, and 332) may be performed in multiple ways. In a first example, each of the edge devices 310-330 may share its edge-specific parameters of their model with each other. This can be done in broadcast, sequentially, etc. In this example, one edge device (e.g., edge device 310) can acquire the edge-specific parameters of several other devices in the community at the same time or sequentially. Then the original parameters on the edge device 310 can be updated based on all of the shared parameters. As an alternative example, the edge devices 310-330 may share their parameters and then computes a new parameter (e.g., average parameter values) based on the received parameters. Each edge device may arrive at the same average parameter because all edge devices may acquire the other edge devices parameters (and their own) and create an average value for the parameters. Each edge device 310-330 may compare its current parameters with the new parameters and determine a delta (difference) between its current specific-parameters and the average parameters of the group and send the delta to each of the other edge devices.

Each edge device may maintain its own edge-specific parameters for the ML model which include weights, coefficients, etc., which are unique to the edge device. However, the edge device may also contain a virtual component (virtual model 340 shown in FIG. 3A) which includes virtual parameters which are averaged, or otherwise shared among each of the edge devices in a cluster or group. The edge device may update or modify its current ML model based on both its specific parameters as well as group parameters included in the virtual component. Over time, updated models may begin to converge such as shown in the curves of FIG. 3B. In some embodiments, incoming data may be filtered first based on the virtual component that is shared among edge devices and then further refined based on edge-specific components that are unique to a particular edge device. The unique components may be unique to the location, data, type of sensors, etc., that are associated with or providing data to the edge device.

According to various embodiments, an edge device may update an AI model using the data from that same device. Furthermore, the edge device may also update the AI model based on common/shared components (parameters) of AI models on other edge devices. For example, each edge device may send (a subset of) the parameters of its specific model to the neighboring edge devices, and vice versa, enabling the edge devices to each calculate an average parameter value. Each edge device may also update its local (unique) parameter based on a weighted average of the parameters it receives. As an alternative example, each edge device may determine and send an update delta to the neighboring edge devices, and vice versa, enabling each edge device to update its AI model based on the delta received from other edge devices plus its own delta.

According to various embodiments, each edge model may be a combination of a specific model component unique to the edge device (sensors, location, data, etc.) and a virtual average model based on parameters of all edge devices in the group or cluster. In some embodiments, each edge device does not keep an exact copy of the parameters of common model component, but only the latest local update. The parameters of the common model on each edge device converges to the same value. In another example, each edge device may keep at least two sets of parameters, where one set is updated using parameter values and the other updated with deltas, but with different weights.

According to various models, an edge device may trigger an AI model update based on various scenarios. For example, an edge-to-edge AI model update may be triggered by an edge device in response to the edge device receiving new data. As another example, the update may be triggered in response to the edge device detecting significant changes between a local (edge specific) model and a virtual model. As another example, the update may be triggered in response to another edge device pushing an updated model to the edge device. As another example, the updated may be triggered by the edge device in response to installation of new hardware or a new configuration, such as addition or loss of sensors.

In some embodiments, edge devices within the same cluster/group may collect different types of data (i.e., heterogenous data). For example, sensor data or the frequency of data for each edge device may be configured differently. As a non-limiting example, one edge device might receive high frequency temperature data and the other device might receive high frequency pressure data. Instead of exchanging raw data, the information is exchanged via the update procedures described herein.

In some embodiments, activity learning may be performed. In this case, the sensitivity of model parameters to each sensor measurement sequence may be computed. The sensitivity of the virtual model to the sensor measurement on each edge device is then computed and compared via the update procedures. In some embodiments, the edge device having the sensor measurement with the largest sensitivity or the smallest sensitivity may be the edge device to trigger a change in data collection setting in the corresponding edge device.

Also, in the examples herein, the communication among edge devices may be distributed. Each device can trigger an update for its neighboring devices based on its own decision-making result. Then this device broadcast the parameters, deltas, and other information (as described in earlier sections) in to the neighboring network or the global network. The devices subscribed to this broadcast all have a filter and a decision-making mechanism to decide whether an update is necessary. The update can also incorporate part of the data received or whole data set.

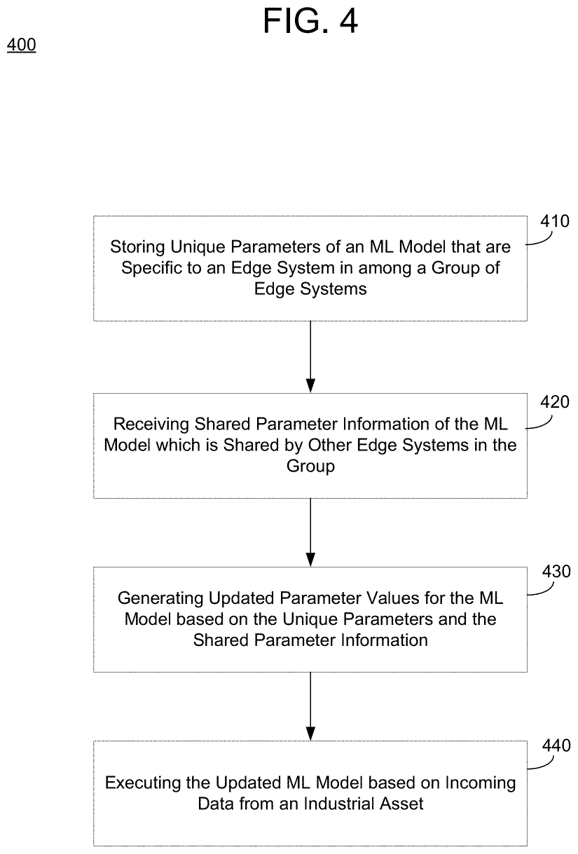

FIG. 4 illustrates a method 400 for updating parameters of an ML model on an edge device in accordance with an example embodiment. For example, the method 400 may be performed by an edge device such as a computing system connected to or embedded within an industrial asset, a cloud computing platform, web server, a database, and the like, or a combination of devices such as a combination of a cloud platform and an edge computing system. Referring to FIG. 4, in 410 the method may include storing, by an edge system among a group of edge systems, unique parameters of a machine learning model associated with an industrial asset which are unique with respect to unique parameters of other edge systems in the group of edge systems. For example, the unique parameters may include one or more of a weight and a coefficient used by the ML model. The unique parameters may be unique to a specific edge device among a plurality of edge devices in the group. Here, the specific parameters of the ML model may not be used by the other edge systems.

In 420, the method may include receiving common parameter information from the group of edge systems which is shared among the group of edge systems. Here, the common parameter information may include information that is commonly shared among each of the edge devices within the group. For example, each edge device may share its parameters with other edge devices. As another example, each edge device may share a delta value with other edge devices in the group. The delta value may correspond to a difference between parameter values used by an edge system with respect to an average parameter value or median parameter value used by all edge systems in the group. For example, the common parameter information may represent a virtual average of parameter values of the ML model among all other edge systems within the group of edge systems.

In 430, the method may include generating updated parameter values for an ML model based on a combination of the unique parameters and the received common parameter information. For example, an edge system may change one or more weights or coefficients of the ML model based on the parameters received from the group while also changing one or more of the weights or coefficients based on edge-specific components.

In 440, the method may include executing the updated ML model based on incoming data from the industrial asset to generate predictive information about the industrial asset. In some embodiments, the incoming data may include image data captured by an imaging sensor, and the updated ML model may be configured to detect regions of interest of the industrial asset based on the image data. In some embodiment, the incoming data may include time-series data captured by one or more sensors, and the updated ML model is configured to identify changes in an operating characteristic of the industrial asset based on the time-series data.

In some embodiments, the method may further include transmitting respective common parameter information of the edge system to at least one of the other edges systems within the group of edge systems. Here, the edge system may share its edge-specific parameter information with other edge systems in the same group.

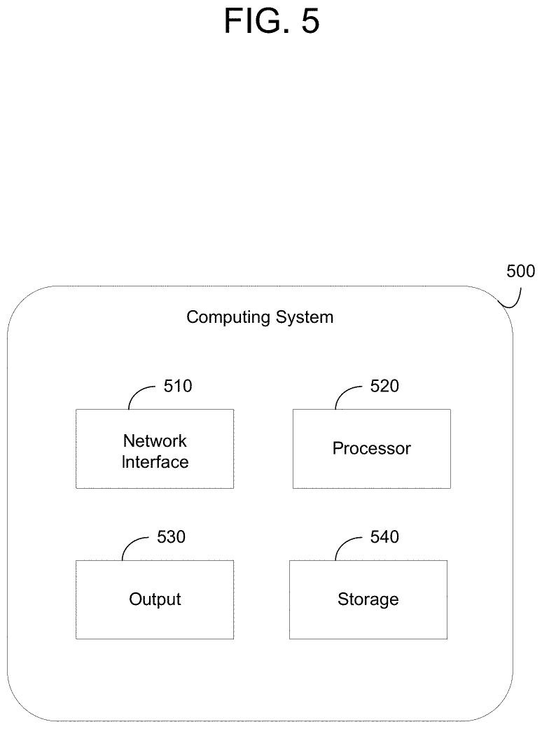

FIG. 5 illustrates a computing system 500 for use in accordance with an example embodiment. For example, the computing system 500 may be an edge computing device, a cloud platform, a server, a database, and the like. In some embodiments, the computing system 500 may be distributed across multiple devices such as both an edge computing device and a cloud platform. Also, the computing system 500 may perform the method 400 of FIG. 4. Referring to FIG. 5, the computing system 500 includes a network interface 510, a processor 520, an output 530, and a storage device 540 such as a memory. Although not shown in FIG. 5, the computing system 500 may include other components such as a display, an input unit, a receiver, a transmitter, and the like.

The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the computing system 500, an externally connected display, a display connected to the cloud, another device, and the like.

The storage device 540 is not limited to a particular storage device and may include any known memory device such as RAM, ROM, hard disk, and the like, and may or may not be included within the cloud environment. The storage 540 may store software modules or other instructions which can be executed by the processor 520 to perform the method 400 shown in FIG. 4. Also, the storage 540 may store software programs and applications which can be downloaded and installed by a user.

According to various embodiments, the storage 540 may store unique parameters of a machine learning model associated with an industrial asset which are unique to the edge system with respect to unique parameters of other edge systems among a group of edge systems. The network interface 510 may receive common parameter information from the group of edge systems which is shared among the group of edge systems. The processor 520 may generate updated parameter values for an ML model based on a combination of the unique parameters and the received common parameter information, and execute the updated ML model based on incoming data from the industrial asset to generate predictive information about the industrial asset.

For example, the incoming data may include image data captured by an imaging sensor, and the updated ML model executed by the processor 520 may be configured to detect regions of interest of the industrial asset based on the image data. As another example, the incoming data may include time-series data captured by one or more sensors, and the updated ML model executed by the processor 520 may be configured to identify changes in an operating characteristic of the industrial asset based on the time-series data.

In some embodiments, the unique parameters may include one or more of unique weights and unique coefficients of the ML model which are used by the edge system but which are not used by the other edge systems. In some embodiments, the common parameter information comprises information about parameters of the ML model which are shared by other edge systems within the group of edge systems. In some embodiments, the common parameter information may include delta parameter information of another edge system which indicates a difference between a unique parameters of the other edge system with respect to average parameters among the group of edge systems. In some embodiments, the common parameter information may represent a virtual average of parameter values of the ML model among all other edge systems within the group of edge systems.

In some embodiments, the processor 520 may control the network interface 510 to transmit respective common parameter information of the edge system to at least one of the other edges systems within the group of edge systems.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. An edge system comprising:
a storage configured to store unique parameters of a machine learning (ML) model associated with an industrial asset which are unique to the edge system with respect to unique parameters of other edge systems among a group of edge systems;
a network interface configured to receive common parameter information from the group of edge systems which is shared among the group of edge systems; and
a processor configured to generate updated parameter values for an ML model based on a combination of the unique parameters and the received common parameter information, and execute the updated ML model based on incoming data from the industrial asset to generate predictive information about the industrial asset.

2. The edge system of claim 1, wherein the common parameter information comprises information about parameters of the ML model which are used by other edge systems within the group of edge systems.

3. The edge system of claim 1, wherein the common parameter information comprises delta parameter information of another edge system which indicates a difference between a unique parameters of the other edge system with respect to average parameters among the group of edge systems.

4. The edge system of claim 1, wherein the unique parameters comprise one or more of unique weights and unique coefficients of the ML model which are used by the edge system but which are not used by the other edge systems.

5. The edge system of claim 1, wherein the processor is further configured to control the network interface to transmit respective common parameter information of the edge system to at least one of the other edges systems within the group of edge systems.

6. The edge system of claim 1, wherein the common parameter information represents a virtual average of parameter values of the ML model among all other edge systems within the group of edge systems.

7. The edge system of claim 1, wherein the incoming data comprises image data captured by an imaging sensor, and the updated ML model is configured to detect regions of interest of the industrial asset based on the image data.

8. The edge system of claim 1, wherein the incoming data comprises time-series data captured by one or more sensors, and the updated ML model is configured to identify changes in an operating characteristic of the industrial asset based on the time-series data.

9. A method comprising:
storing, by an edge system among a group of edge systems, unique parameters of a machine learning (ML) model associated with an industrial asset which are unique with respect to unique parameters of other edge systems in the group of edge systems;
receiving common parameter information from the group of edge systems which is shared among the group of edge systems;
generating updated parameter values for an ML model based on a combination of the unique parameters and the received common parameter information; and
executing the updated ML model based on incoming data from the industrial asset to generate predictive information about the industrial asset.

10. The method of claim 9, wherein the common parameter information comprises information about parameters of the ML model which are used by other edge systems within the group of edge systems.

11. The method of claim 9, wherein the common parameter information comprises delta parameter information of another edge system which indicates a difference between a unique parameters of the other edge system with respect to average parameters among the group of edge systems.

12. The method of claim 9, wherein the unique parameters comprise one or more of unique weights and unique coefficients of the ML model which are used by the edge system but which are not used by the other edge systems.

13. The method of claim 9, further comprising transmitting respective common parameter information of the edge system to at least one of the other edges systems within the group of edge systems.

14. The method of claim 9, wherein the common parameter information represents a virtual average of parameter values of the ML model among all other edge systems within the group of edge systems.

15. The method of claim 9, wherein the incoming data comprises image data captured by an imaging sensor, and the updated ML model is configured to detect regions of interest of the industrial asset based on the image data.

16. The method of claim 9, wherein the incoming data comprises time-series data captured by one or more sensors, and the updated ML model is configured to identify changes in an operating characteristic of the industrial asset based on the time-series data.

17. A non-transitory computer readable medium storing instructions which when executed are configured to cause a processor to perform a method comprising:
storing, by an edge system among a group of edge systems, unique parameters of a machine learning (ML) model associated with an industrial asset which are unique with respect to unique parameters of other edge systems in the group of edge systems;
receiving common parameter information from the group of edge systems which is shared among the group of edge systems;
generating updated parameter values for an ML model based on a combination of the unique parameters and the received common parameter information; and
executing the updated ML model based on incoming data from the industrial asset to generate predictive information about the industrial asset.

18. The non-transitory computer readable medium of claim 17, wherein the common parameter information comprises information about parameters of the ML model which are used by other edge systems within the group of edge systems.

19. The non-transitory computer readable medium of claim 17, wherein the common parameter information comprises delta parameter information of another edge system which indicates a difference between a unique parameters of the other edge system with respect to average parameters among the group of edge systems.

20. The non-transitory computer readable medium of claim 17, wherein the unique parameters comprise one or more of unique weights and unique coefficients of the ML model which are used by the edge system but which are not used by the other edge systems.
